(19) United States
(12) Patent Application Publication
(10) Pub. No.: US 2021/0172774 A1
(43) Pub. Date: Jun. 10, 2021

(54) VOLUMETRIC FLOW SENSOR FOR TUBULAR CONDUITS AND METHOD

(71) Applicant: KING ABDULLAH UNIVERSITY OF SCIENCE AND TECHNOLOGY, Thuwal (SA)

(72) Inventors: Maha Ahmed NOUR, Thuwal (SA); Muhammad Mustafa HUSSAIN, Hercules, CA (US)

(21) Appl. No.: 17/116,757

(22) Filed: Dec. 9, 2020

Related U.S. Application Data
(60) Provisional application No. 62/946,197, filed on Dec. 10, 2019.

(51) Int. Cl. G01F 1/36; G01F 1/42

(52) U.S. Cl. CPC G01F 1/363; G01F 1/42

(57) ABSTRACT

A flowmeter for measuring a fluid flow rate in a pipe includes a base made of a flexible material; a bridge made of a rigid material, wherein the bridge is attached to the base to form a microchannel; and a pressure sensor formed within the base. The microchannel has a height H between 100 and 400 μm.

### CROSS-REFERENCE TO RELATED APPLICATIONS

This application claims priority to U.S. Provisional Patent Application No. 62/946,197, filed on Dec. 10, 2019, entitled “VOLUMETRIC FLOW SENSOR FOR TUBULAR ARCHITECTURES,” the disclosure of which is incorporated herein by reference in its entirety.

### BACKGROUND

### Technical Field

Embodiments of the subject matter disclosed herein generally relate to a volumetric flow sensor and a method for measuring a volumetric flow rate, and more particularly, to a microfluidic channel based sensor for macro-tubular conduits.

### Discussion of the Background

Flow rate measurements in macro-tubes such as pipes are important in determining the performance of various applications for many industries, including agriculture industry, oil and gas, chemicals, water transportations, and desalination. Measuring the flow rates (measured as volume over time) are an essential requirement in product quality control, process analysis, efficient energy management and material utilization such as waste reduction, accounting of yield, and consumption for fluidic industries products.

With the growth of fluidic industries, many different types of flow rate sensing techniques have been established for tubular systems. Some of the prominent technologies are pressure-difference based flowmeters, thermal, turbine flowmeter, electromagnetic, vortex, ultrasonic sensors, and the Coriolis flowmeter. However, these types of flow sensors are bulky, rigid, and not compatible with curved tubular architectures. Therefore, the existing sensors significantly disturb the fluid's velocity inside the pipe, causing permanent and notable pressure drops, except for those non-invasive flowmeters such as the ultrasonic and electromagnetic sensors that are mounted to the outside wall of the pipe. However, magnetism based flowmeters are not suitable for the majority of fluids because of their limitations to electrically conductible fluids only. The ultrasonic flowmeters are large, and it is hard to accurately achieve measurements. The Coriolis flowmeters provide precise measurements, but they are relatively expensive and also generate large pressure drops in the fluid steams in which they are placed. Although several other different types of pipe flowmeters are available on the market, there is still a demand for development and improvement of flow sensors since each type has certain limitations.

One of the methods that addresses the above mentioned issues could be the utilization of microsensors placed inside the tubular systems that need to be monitored. Microfluidic flow sensors have been developed in the last decade for measuring the flow rate in small volumes, such as biomedical and analytical chemistry applications ([1], [2]). Some of these micro-flow sensors are based on micro-electromechanical systems (MEMS), optical, thermal, or pressure-based measurement flow sensing technology ([3], [4], [5], [6]). The use of microfabrication sensors provide several advantages such as increasing reliability, performance, functionality, and lowering the cost with decreasing the device dimensions [7].

Therefore, using the advantages of the microfluidic sensors in the tubular systems can overcome the main challenges of the existing flow sensors. However, the existing microfluidic flow sensors still have a complex structure, are fragile and are not very accurate.

Thus, there is a need for a new volumetric flow rate sensor (flowmeter) that overcomes the above noted deficiencies of the existing sensors, is inexpensive, accurate, and appropriate for being located in a large or small pipe.

### BRIEF SUMMARY OF THE INVENTION

According to an embodiment, there is a flowmeter for measuring a fluid flow rate in a pipe. The flowmeter includes a base made of a flexible material; a bridge made of a rigid material, wherein the bridge is attached to the base to form a microchannel, and a pressure sensor formed within the base. The microchannel has a height H between 100 and 400 μm.

According to another embodiment, there is a flowmeter system for measuring a fluid flow rate in a pipe, and the flowmeter system includes a flowmeter having a base made of a flexible material, a bridge made of a rigid material, wherein the bridge is attached to the base to form a microchannel, and a pressure sensor formed within the base. The flowmeter system also includes a microcontroller configured to receive a pressure reading from the pressure sensor and to estimate the fluid flow rate through a pipe in which the flowmeter is located.

According to yet another embodiment, there is a method for measuring a fluid flow rate through a pipe. The method includes attaching a flowmeter to an inside of a pipe, the flowmeter having a base made of a flexible material that directly attaches to the inside of the pipe, a bridge made of a rigid material, wherein the bridge is attached to the base to form a microchannel, and a pressure sensor formed within the base; flowing a fluid through the pipe so that part of the fluid flows through the microchannel; measuring a pressure of the fluid within the microchannel with the pressure sensor; and determining the flow rate of the fluid through the pipe based on the measured pressure within the microchannel.

### BRIEF DESCRIPTION OF THE DRAWINGS

Fora more complete understanding of the present invention, reference is now made to the following descriptions taken in conjunction with the accompanying drawings, in which:

FIG. 1 is a schematic diagram of a flowmeter, which is placed inside of a pipe, for measuring a fluid flow rate through the pipe;

FIG. 2 illustrates various elements of the flowmeter;

FIG. 3 is a cross-section of a microchannel used by the flowmeter for measuring the flow rate of the fluid;

FIG. 4 shows a pressure sensor formed within a base of the flowmeter for measuring a pressure within the microchannel;

FIG. 5 shows the placement of the flowmeter within a pipe and the small height of the microchannel relative to the diameter of the pipe;

FIG. 6 is a graph showing a flow rate of the fluid through the microchannel versus the flow of the liquid through the pipe, and also showing a relationship between the pressure inside the microchannel versus the fluid flow through the pipe;

FIGS. 7A and 7B illustrate a beginning part of the manufacturing process of the base and pressure sensors of the flowmeter;

FIG. 8 illustrates the relationship between the capacitance of the pressure sensor and the measured pressure within the microchannel for the flowmeter;

FIGS. 9A to 9C illustrate a final part of the manufacturing process of the flowmeter in which a bridge is added to the base to form the microchannel;

FIG. 10 shows a set up for testing the manufactured flowmeter;

FIG. 11 illustrates the relationship between the measured relative capacitance of the flowmeter and the flow rate within the pipe;

FIG. 12 illustrates a flowmeter system in which the flowmeter communicates with an external device through a wire that extends through the wall of the pipe in which the flowmeter is located;

FIG. 13 illustrates another flowmeter system in which the flowmeter communicates with an external device in a wireless manner through the wall of the pipe in which the flowmeter is located;

FIGS. 14A to 14C illustrate the signal received from various pressure sensors of the flowmeter system, at the external device, using the wireless implementation; and

FIG. 15 is a flow chart of a method for measuring a flow rate of a fluid in a pipe with a flowmeter having a microchannel disposed inside the pipe.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a physically flexible liquid flow sensor that is placed inside a tubular pipe and measures a pressure inside the sensor with three pressure sensors. However, the embodiments to be discussed next are not limited to a flexible flow sensor, or to a sensor that is placed inside a tubular pipe, or to a sensor having three pressure sensors, but they may be applied to a rigid sensor and/or to a pipe having any profile, and/or a sensor having more or less pressure sensors.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a flowmeter includes a firm microfluidic channel bridge placed on a physically and mechanically flexible base. This assembly is installed on the inner wall of a tubular system. The flexible platform provides device compatibility with different tubular architectures and curvatures adoptions. The micro-scale fluidic channel overcomes the main disadvantages of the common bulky and rigid flowmeters, which cause flow streams disturbance and significant pressure drops in tube systems. The microchannel flowmeter is based on detecting the dominating dynamic pressure generated by the fluid velocity inside the microchannel as the fluid flow rate through the microchannel is proportional to the flow velocity inside the microchannel. The one or more pressure sensors for the microchannel flowmeter is fabricated inside the base, and they have a sensitivity equal to 10 pf/KPa. The pressure measurement is based on a capacitive pressure sensor because it is compatible with the flexible electronics and it provides low power consumption.

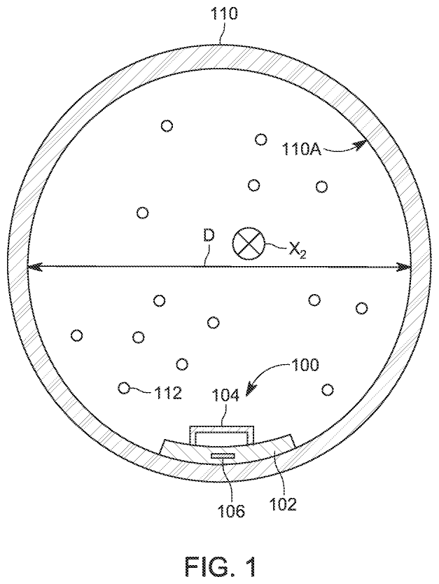

More specifically, as shown in FIG. 1, a novel liquid volumetric flowmeter (called herein simply flowmeter) 100 is placed inside a pipe 110 having an internal diameter D. The diameter D can be between 1 cm to any larger size. The flowmeter 100 has a base 102 that is placed on the internal surface 110A of the pipe 110, a bridge 104 attached to the base 102, and one or more pressure sensors 106 located in the base 102. While FIG. 1 shows the pipe 110 having a circular cross-section, the flowmeter discussed herein is configured to work in a pipe having any cross-section, e.g., rectangular, square, triangular, etc. The base 102 can be made of a flexible material, e.g., polydimethylsiloxane (PDMS), so that the base 102 follows intimately the profile of the internal surface 110A of the pipe 110. Other flexible materials may be used as long as they can bend enough to follow the profile of the internal surface of the pipe. However, in another embodiment, the base 102 is made of a rigid material, which does not follow the profile of the internal surface 110A, in which case a liquid pocket may be formed between the base and the internal surface of the pipe.

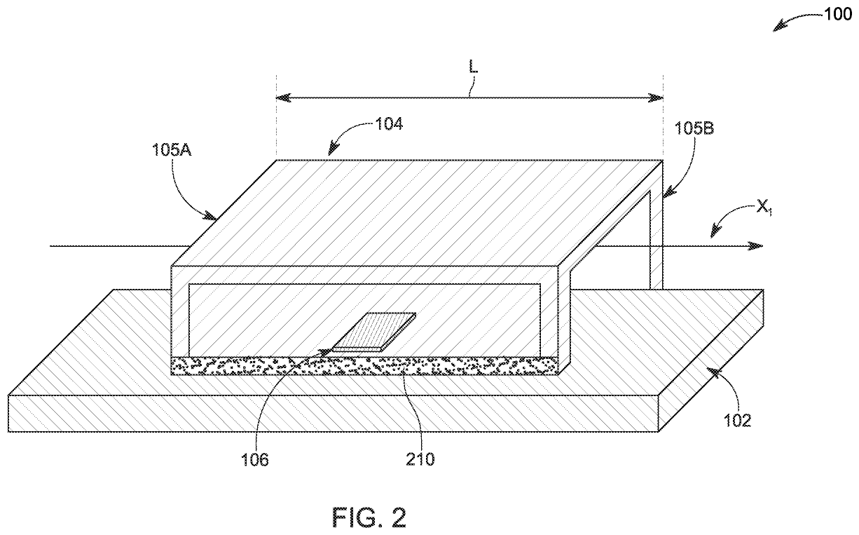

The flowmeter 100 is shown in FIG. 2 as extending along a longitudinal axis X1, which is parallel to the longitudinal axis X2 (shown in FIG. 1 as entering the page) of the pipe 110. For simplicity, the pipe 110 is omitted in FIG. 2. The base 102 is shown in this figure as being flat, and having a footprint larger than the bridge 104. The bridge 104 is made of a rigid material, for example, poly(methyl-methacrylate) (PMMA), so that an external pressure exerted by the fluid 112, which flows through the pipe 110, on the bridge, does not deform the walls of the bridge. This condition is desired because the pressure sensor 106's readings should be indicative of only the liquid's pressure inside the bridge, and not be influenced by the liquid pressure outside the bridge.

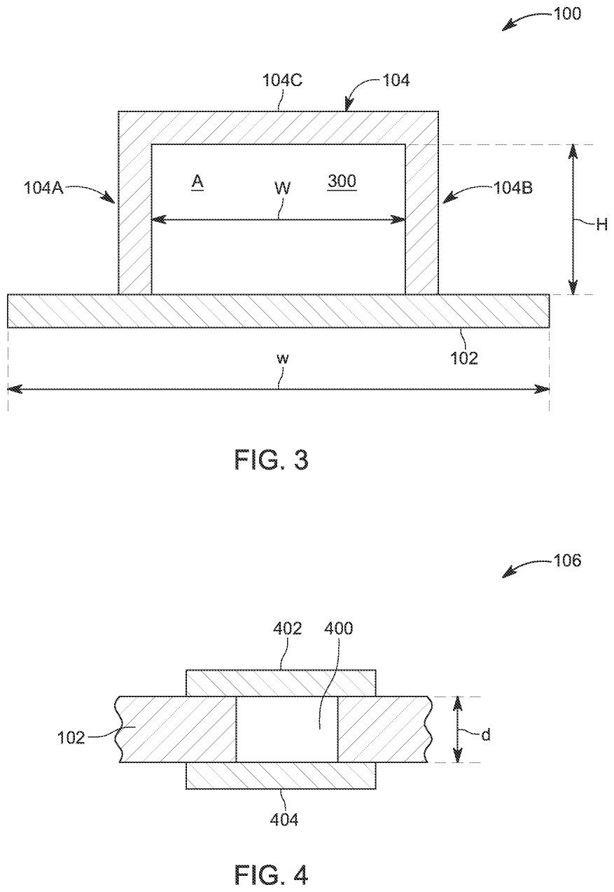

FIG. 3 shows a cross-sectional view of the base 102 and the bridge 104. The bridge 104, when attached to the base 102, forms an enclosed volume, which defines the microchannel 300. The bridge 104 has two side walls 104A and 104B, and a top wall 104C. There is no bottom wall for the bridge, and thus the name “bridge.” The two side walls and the top wall define the trench or microchannel 300. The sizes of the microchannel are the height H, the width W, and the length L. The height H is selected to obtain the microchannel 300, i.e., a channel for fluid flow which is in the micrometer range. More specifically, the microchannel 300 has a height H between 100 and 400 μm, with a preferred size of substantially 250 μm. The term substantially is defined herein to include any variation of the height within +1-10% of the given value. The width W of the microchannel 300 is selected to be about 3 mm and the length L is selected to be between 3 to 100 mm, with a preferred length of about 60 mm. It is noted that a channel that has the height H larger than 500 μm would likely not work with the concept to be discussed later. A cross-section area A of the microchannel 300 is square in FIG. 3, but other shapes may be selected.

The bridge 104 is made to be solid and have no openings, except for the input 105A and the output 105B. This means that the bridge 104 is attached to the base 102, for example, with a glue 210, so that no fluid enters or exists the microchannel 300 except for the input 105A and the output 105B. The bridge 104 may be attached to the base 102 by other means, e.g., mechanical means, thermal means, etc. The width W of the bridge is shown in FIGS. 2 and 3 to be smaller than the width w of the base 102. In one application, the width W is much smaller than the width w, i.e., it can be a couple of times (2 to 10) smaller. This situation happens when it is desired that the width w of the base 102 is made to be almost the same to the internal circumference of the surface 110A of the pipe 110. By making the width w of the base so large, it is possible to further fix the flowmeter to the internal surface of the pipe due to the natural adherence properties of the PDMS material, i.e., without using a glue or a mechanical means.

The pressure sensor 106 is shown in FIG. 4 having a top electrode 402 and a bottom electrode 404 that sandwich a hole 400 formed into the base 102. The hole 400 may be filled with air or with any other dielectric material. The two electrodes 402 and 404 and the air pocket 400 act as a capacitive pressure sensor, so that when the fluid inside the microchannel 300 has a higher pressure, it squeezes the top plate 402 toward the bottom plate 404, which results in the dielectric air gap 400 being reduced. This change in the thickness of the dielectric material can be measured with corresponding electronics and associated with the pressure exerted by the liquid on the pressure sensor, as discussed later. More then one pressure sensors may be formed in the base 102 to improve the reading's accuracy. Note that the pressure sensor 106 has one electrode directly exposed to the fluid flowing through the microchannel 300 and also that electrode is fully formed within the microchannel 300.

The flowmeter illustrated in FIGS. 1 to 4 does not require an external flow path or tube contractions to prevent fluid flow interruption, pressure drop, and/or energy loss. Instead, the flowmeter uses the volumetric flow rate generated inside the tubular system 110 to drive a small fluidic volume inside the microchannel 300 for volumetric flow rate measurement under the laminar flow condition using the microfabrication advantages. In other words, the flowmeter 100 uses exclusively the microchannel 300 for performing a pressure measurement of only the fluid flowing through the microchannel and from this information, estimates the flow rate of the fluid inside the pipe.

As previously discussed, the base of the flowmeter is made as a physically flexible platform to adapt to different pipe diameters and curved architectures. The designed flowmeter's base, which is made of PDMS, has excellent physical and chemical properties since it is compatible with the microfabrication process, provides high flexibility, thermal stability, and is a low-cost material. The PDMS base contains one or more pressure sensors 106, which are based on a capacitive mechanism. The capacitive pressure sensor 106 was selected among other pressure sensing technologies because of the high stability and reliability even under mechanical deformations and it can be tailored easily with different sizes for different sensing pressure ranges. Therefore, it can provide good sensitivity of the flow's pressure for different pipe diameters and bending radii. The PDMS base may patterned to include encapsulated air, which is used as the dielectric material for the pressure sensor, and which is sandwiched between sputtered copper layers on the PDMS base, which act as conductive parallel plates for the capacitive structure.

The rigid microchannel bridge 104 was installed on top of the capacitive pressure sensor 106 on the base 102 to form the fluidic microchannel 300 because it is not possible, in large scale cross-section areas, i.e., for pipes, to measure the flow rate directly using the pressure change in the pipe. Because the static pressure generated by the fluid's weight inside the pipe 110 is much higher than the dynamic pressure generated by the fluid flow, by creating the microchannel 300, the size of the static pressure term is reduced, to be less than the dynamic pressure term. Note that the static pressure is multiplied by the microchannel height (which is less than 500 μm), and the dynamic pressure is divided over the square of the cross-section area A of the microchannel 300 (the area is very small, which makes the dynamic pressure large). Therefore, the bridge 104 provides a small cross-section area A regardless of the pipe 110's dimensions, which makes the dynamic pressure to dominate over the static pressure. For this reason, the microchannel 300 is made of a solid material, e.g., PMMA, to avoid channel deformation under different applied pressures from the surrounding fluidic environment. Also, the PMMA material is compatible with the PDMS base and the microfluidic fabrication processes.

The design of the microchannel 300 with micro-sized height H and a rectangular cross-section area offers a negligible flow disturbance in the pipe, compared to the existing technologies that generate large pressure drops and energy losses due to their large size. Another advantage of the microchannel 300 is the formation of a constant cross-section area A regardless of the pipe's dimensions. This means that no special correction is needed for different pipe diameters. Moreover, the Reynold number is small for the microchannel 300 because it is proportional to its height. Therefore, the microchannel provides a laminar flow irrespective of the flow type in the pipe 110. The laminar flow simplifies the overall system physics and mathematical equations.

The operating principle of the flowmeter 100 is now discussed in more detail. The capacitive pressure sensor 106 inside the microchannel 300 is placed to measure the absolute pressure Pₜₒₜₐₗ generated by (1) the fluid's weight and (2) the fluid flow's velocity inside the microchannel 300. The measured pressure using the capacitive pressure sensor 106 corresponds to the total pressure P_{Total}, which is a combination of the static pressure P_{Static} and the dynamic pressure P_{Dynamic}, as expressed in equation (1).

P_{Total}=P_{Static}+P_{Dynamic}. (1)

The dynamic pressure P_{Dyamic} is proportional to the square of the volumetric flow rate Q of the fluid, as expressed in equation (2), while the static pressure P_{Static} is proportional to the high of the microchannel 300.

$${P}_{Total} = ρ g H + \frac{1}{2} ρ \frac{{Q}^{2}}{{A}^{2}} , \qquad ( 2 )$$

where ρ is the liquid density, H is the microchannel 300's height, and g is the gravity acceleration.

The total pressure is measured using the capacitive pressure sensor 106, where its capacitance value is proportional to the applied pressure, as shown by equation (3):

$$C = \frac{{ɛ}_{0} {ɛ}_{r} {A}_{1}}{d} , \qquad ( 3 )$$

where d is the thickness of the base 102, as shown in FIG. 4, which also coincides with the thickness of the dielectric pocket of air 400, εᵣ is the dielectric relative permittivity of the material (air in this case), ε₀ is the permittivity of the free space (8.854×1012 F/m), and A₁ is the area of the conductive parallel plates 402, 404, which have the sizes of 3 mm×3 mm in this embodiment. Other sizes and shapes may be used.

When the pressure exerted by the fluid 112 inside the microchannel 300 increases, the dielectric layer's height d decreases, and thus the capacitance C value of the pressure sensor 106 increases. Thus, based on the readings from the capacitor, it is possible to calculate the pressure inside the microchannel 300. Knowing the exact profile of the microchannel 300 and also the profile and sizes of the pipe 110, it is then possible to link the pressure readings to the flow rate within the pipe 110.

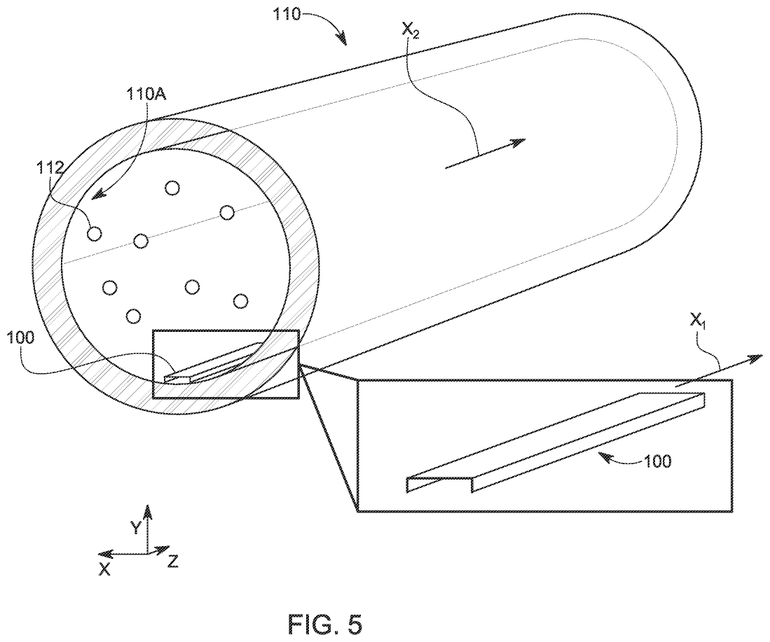

The simulated capabilities of the flowmeter 100 were studied using a numerical analysis performed with a commercially available tool. The numerical analysis was performed to understand the relationship between the microchannel 300's flow rate and the pipe 110's flow rate and to ensure fully developed flow conditions inside the microchannel 300. The simulation replicates the fluid flow dynamics inside a 3-dimensional (3D) pipe that was based on the Navier-Stock equation. The microchannel's dimensions were set to be 250 μm for the high H, 3 mm for the width W, and 60 mm for the length L. The simulated microchannel was attached to an internal wall 110A of the tube 110 with a 3.8 cm inner diameter, as illustrated in FIG. 5. The flowmeter 100 is placed into the tube 110 so that the microchannel 300 has its longitudinal axis X1 parallel to the longitudinal axis X2 of the tube 110. This arrangement is also used when the actual flowmeter 100 is placed into an actual tube or pipe. FIG. 5 shows, at scale, the extremely low profile (i.e., height) of the microchannel 300 relative to the pipe 110. To simplify the calculations, three points were selected inside the inner wall of the microchannel 300, and the pressure measurements were recorded at each of these three selected points. Thus, in this embodiment, three different pressure sensors were formed in the wall of the base 102.

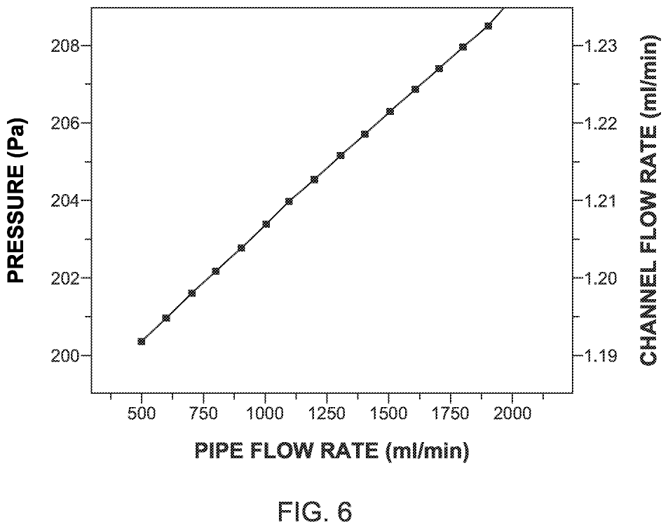

FIG. 6 shows the results of numerical analysis for the flowmeter 100. The numerical analysis was used to find the correlation between the tubular flowrate (flow in the pipe 110) and the microchannel flowrate (flow in the microchannel 300), followed by finding the pressure range at the selected points inside the microchannel 300. As shown in FIG. 6, the flow rate in the microchannel 300 (which is plotted on the Y axis in the graph, on the right hand side) is found to be proportional to the flow rate in the pipe 110 (which is plotted on the X axis in the graph) because the total flow rate is equal to the summation of the flow rates in the individual branches. Also, the results in FIG. 6 show that the pipe flow rate is proportional to the total pressure (plotted on the Y axis in the graph, on the left hand side) at the selected points since the dynamic pressure varies as a function of the fluid's velocity or flow rate. As a result, the pipe flow rate is proportional to the microchannel flow rate as well as the dynamic pressure generated on the channel's walls, which ensures that the pressure readings performed with the pressure sensor 106 inside the microchannels 300 are proportional to the flow rate inside the pipe 110, which is desired to be measured. In other words, this analysis proves that by measuring the pressure inside the microchannel 300, it can be determined the pipe flow rate, i.e., the volumetric flow.

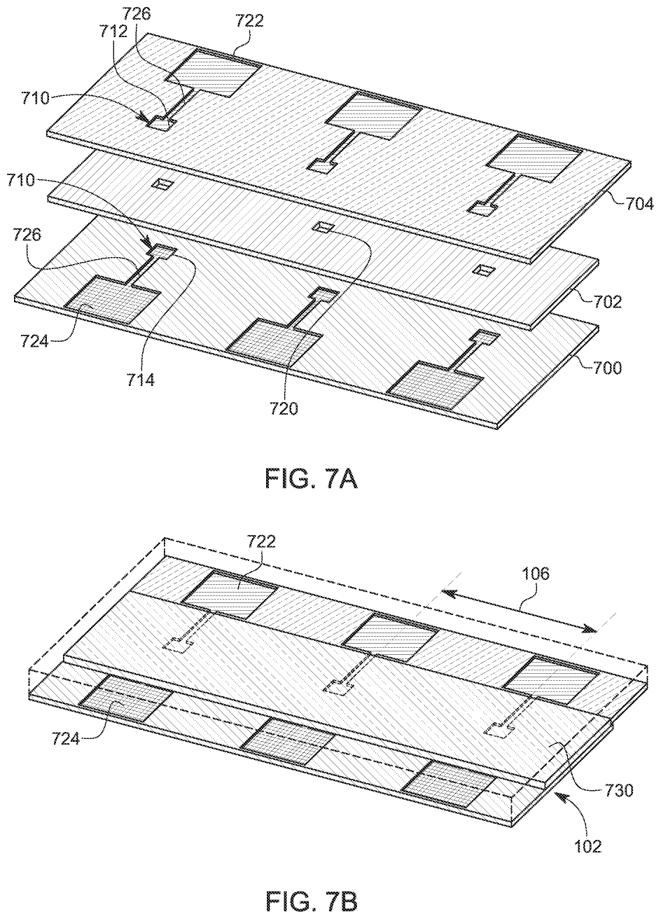

Based on these observations, the flowmeter 100 has been manufactured as now discussed. In this embodiment, the flowmeter 100 was manufactured with a lithography-free process making it a low cost, simple and affordable device. The flowmeter has two parts, which are the rigid PMMA microchannel bridge 104 and the PDMS mechanically flexible base 102 with a capacitive pressure sensor 106 as discussed above. The physically flexible 102 was fabricated as shown in FIGS. 7A and 7B using three PDMS layers 700, 702, and 704. In one application, each of the PDMS layers 700, 702, and 704 has a 500 μm thickness. Other values may be used for the thickness. Kapton tape may be used as a shadow mask on the first and third layers 700 and 704. The Kapton tape is placed to cover the entire surface of the layer and then it was patterned using a CO₂ laser to form 3 mm squares, which correspond to squares 710 on the first and third layers in FIG. 7A. These patterned squares of Kapton tape were peeled off from the surfaces of the two layers to form corresponding active areas for the capacitance pressure sensors 106.

The exposed PDMS surfaces were treated with oxygen plasma to modify the surface from hydrophobic to hydrophilic by increasing the surface roughness to provide better metal adhesion on its surface. Then, these two PDMS layers 700 and 704 were sputtered with 200 nm thickness of copper to form conductive plates 712, 714 for the capacitance sensors. Note that the plate 712 is formed on the top square 710 of the PDMS material for the layer 704 while the plate 714 is formed on the bottom square 710 of the PDMS material for the layer 700, in FIG. 7A. The Kapton tape was then completely removed from the PDMS layers 700 and 704, leaving the active areas with a thin coated layer 712 and 714 of copper.

The second PDMS layer 702 was patterned all the way through the PDMS layer thickness using the CO₂ laser to form trenches or holes 720. These trenches are filled by air, which performs as a dielectric material for the capacitance sensors 106. The three prepared PDMS layers 700, 702, and 704 were arranged in the order shown in FIG. 7A and then the layers were assembled and bonded together, as shown in FIG. 7B, using an oxygen plasma technique by exposing the surfaces to oxygen plasma for 60 seconds followed by bringing the surfaces together. The bonds were enhanced by baking the bonded layers for 60 seconds at 80° C. Copper electrodes 722 and 724 were bonded to the flexible plates 712 and 724, respectively using a silver paste 726. After curing the silver paste, the entire assembly was packaged using a PDMS layer 730 to protect it and protect the copper electrodes 712 and 714, and to fix the positions of the layers 700, 702, and 704 to prevent air leaking.

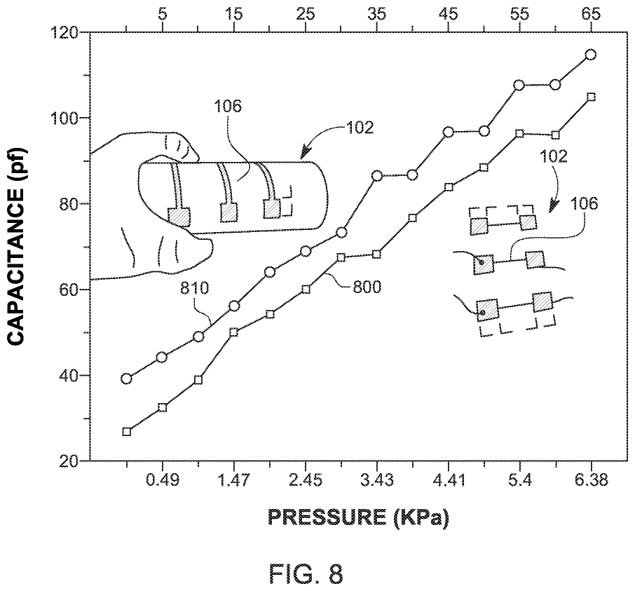

The base 102 having the pressure sensors 106 shown in FIG. 7B has been characterized before adding the bridge 104, as now discussed. Although the capacitance values of the pressure sensors 106 can be correlated directly to the tube 110's flowrate, without finding the exact pressure inside the microchannel 300, as illustrated in FIG. 6, finding the pressure of the pressure sensors 106 gives a better understanding of the flowmeter. Also, it allows to compare the results with the numerical analysis, and to validate the operating condition of the capacitive pressure sensor 106 before characterizing the tubular flow rates. For this stage, the capacitive pressure sensors 106 on the flexible PDMS base 102 in FIG. 7B were characterized before completing the fabrication process of the flowmeter. The pressure sensors 106 were characterized at different water depths, from 0 to 65 cm with a 5 cm incremental depth step, as shown in FIG. 8, on top axis X. The different water depths were projected into different pressure ranges using equations (1) and (2), as illustrated on the bottom axis X. The total pressure is equal to the static pressure (=ρ h g) because the dynamic pressure is equal to zero for this case. For this characterization stage, the values for the three capacitance pressure sensors 106 were recorded at different water depths and then the averaged capacitance readings at each depth were calculated. The pressure sensors were characterized first on a flat surface (see line 800) and then on a concave surface position using a 3.8 cm bending diameter (see line 810). The corresponding capacitances for various depths or pressures are plotted in the figure on the Y axis.

The pressure sensor results for the flexible base 102 show that the capacitance is linearly proportional to the applied pressure and depth, as shown in FIG. 8. Both characterization results for different surface conditions, i.e., flat and concave surfaces, displayed almost the same pressure sensitivity that is equal to 10 pf/KPa. The device showed almost identical behavior under flat and concave surface positions. It is expected that the initial capacitance value is slightly higher for the device experiencing the concave position due to the stress generated from the mechanical deformation of the flexible sensory platform.

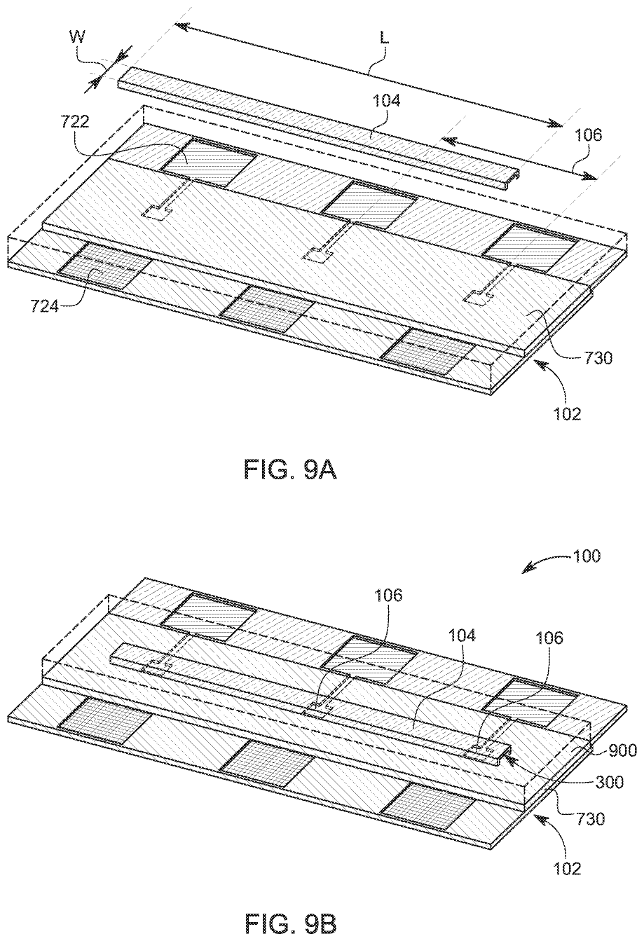

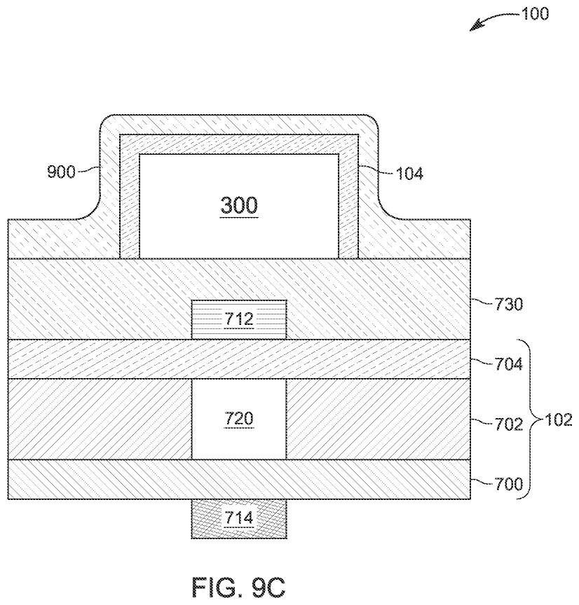

After the pressure sensor characterization, the microchannel bridge 104 was fabricated, as shown in FIG. 9A. The microchannel bridge 104 was fabricated using a 1 mm thickness PMMA sheet. The sheet was patterned using the CO₂ laser to form a 250 μm trench depth into the rectangular shaped piece of the sheet, the rectangular shaped piece having a 3 mm width and a length of 60 mm, as also shown in FIG. 9A. Then, the rectangular shaped piece was cut off from the sheet to obtain the bridge 104 with the trench. After that, the microchannel bridge 104 was attached to the prepared, flexible sensory base 102 using the oxygen plasma bonding method, to obtain the microchannel 300, and essentially the flowmeter 100, as shown in FIG. 9B. To ensure a good bonding between the bridge 104 and the base 102, the flowmeter 100 can be repackaged with a thin PDMS coat 900. A cross-section of the flowmeter 100 obtained with the method discussed herein is shown in FIG. 9C.

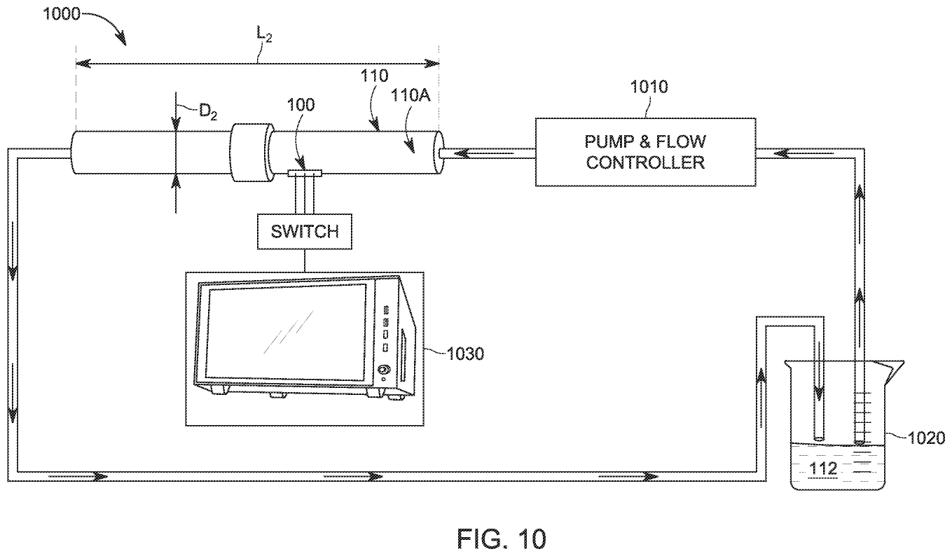

For the next characterization stage, the entire flowmeter 100 was tested as the microchannel 300 was formed by attaching the bridge 104 to the flexible sensory base 102 as previously explained. A laboratory transparent polyvinyl chloride (PVC) pipe system 1000 was built with a 3.8 cm inner diameter D2 and a 60 cm total system's length L2, as shown in FIG. 10. The flowmeter 100 was attached to the inner wall 110A of the pipe 110. The volumetric flow sensor 100 was characterized using a pump controller 1010 (Catalyst FH100DX Pump) to generate a precise flow rate. The pump was connected to the pipe system and to a fluid reservoir 1020. The flowmeter 100 was tested with water 112 at different flow rates, from 0 to 2000 ml/min. Each flow rate was run for 1 minute to stabilize the selected flow rate before collecting data. At each flow rate, the capacitance was recorded from the three pressure sensors 106 using a general-purpose source meter 1030, for example, a Keithley 2400A-SCS.

With this setup, the ΔC/C₀ (called herein the relative change in the capacitance) was calculated for each capacitance, where C and C₀ are the capacitance values with and without an applied pressure. Finally, the three ΔC/C₀ calculated values were averaged for each flow rate. Determining the average for the capacitance reading between the three selected points helps with smoothing the graph and creating a single graph to correlate the recorded capacitance values to the tubular flow rate.

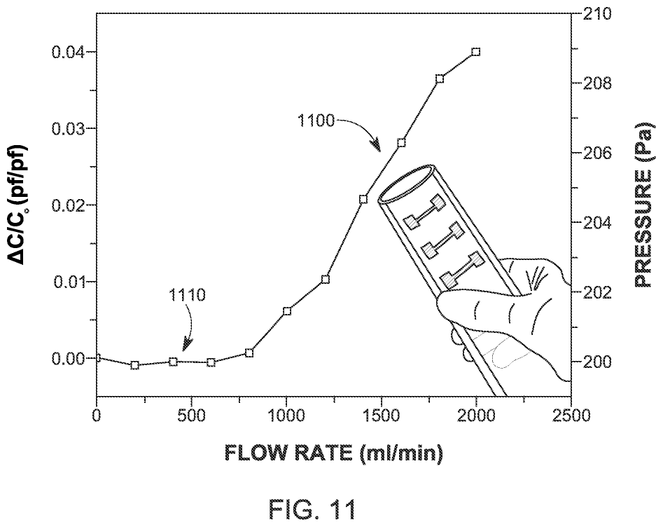

FIG. 11 shows the results of the readings from the flowmeter 100 when operating under different flow rate conditions. As the numerical analysis indicated, the readings of the capacitance pressure sensor 106 are proportional to the flow rate Q in the microchannel 300 and the tubular system 110. The tubular flow rate (plotted on the X axis) is proportional to the microchannel 300's flow rate because the flow streams in the tubular system are generating the driving force for the fluids to flow inside the microchannel as it was explained and proven previously in the numerical validation section. Using equations (1) and (2), it is possible to assert that the microchannel 300's flow rate and the dynamic pressure change proportionally, which in turn increases the total pressure, whereas the static pressure is constant for a particular fluid and temperature. The results show in FIG. 11 indicate that the flowmeter is sensitive from 500 ml/min to 2000 ml/min. This can be explained by the fact that at flow rates lower than 500 ml/min, there is a small force that is not likely to drive the fluid 112 inside the microchannel 300, for the given channel dimensions. In other words, the change in the pressure is lower than the pressure sensitivity range. The almost straight line 1100 shown in FIG. 11 indicates that by using the pressure sensor 106, a controller that receives readings from the flowmeter 100, may be programmed to determine the change in the capacitance of the pressure sensor, and based on the calibrated sensor values, to determine the corresponding flow rate through the pipe 110. The part 1110 of the curve 1100 does not show a unique mapping between the relative change in the capacitance and the flow rate, which means that this part of the curve cannot be used form measuring the volumetric flow through the pipe.

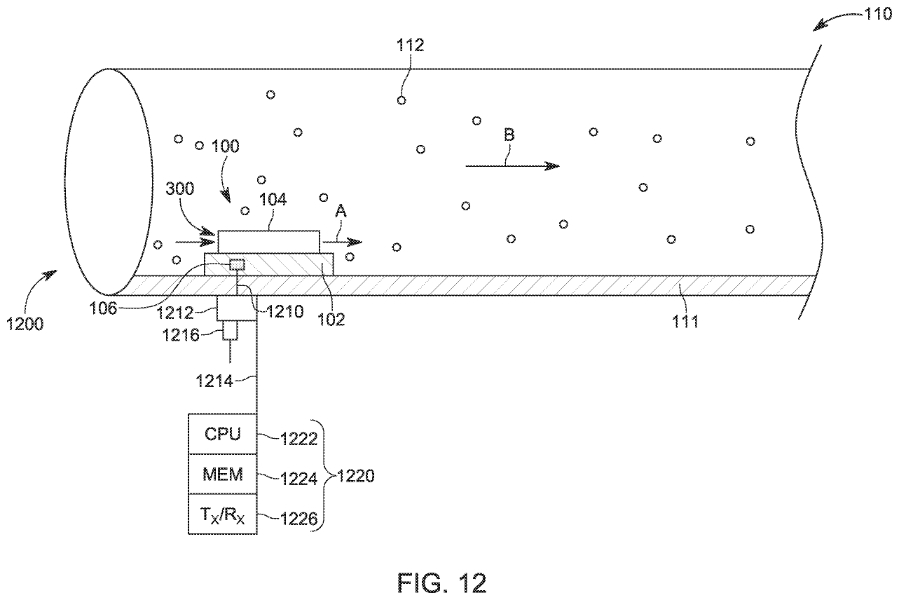

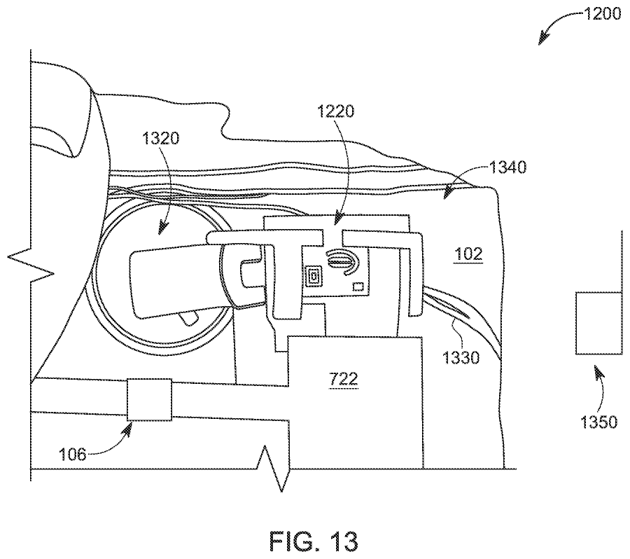

The flowmeter 100 has been shown in the above embodiments as being placed inside the pipe 110 with no wires leaving the sensor. However, for the flowmeter to exchange data with the controller, either a wired communication or a wireless communication needs to be established between the one or more pressure sensors 106 and the controller. Both implementations are possible and both are now discussed with regard to FIGS. 12 and 13. FIG. 12 shows the wired implementation of a flowmeter system 1200 in which one or more wires 1210 extend through the wall 111 of the pipe 110, from the flowmeter 100 to a connection box 1212. The connection box 1212 may include electronics for facilitating data exchange between the flowmeter and an external controller 1220. The figure also illustrates the fluid flow A through the microchannel 300 and the fluid flow B through the pipe 110. If the connection between the pressure sensor 106 and the controller 1220 (which can include a processor 1222 and a memory 1224) is fully wired, then additional wires 1214 electrically connect the connection box 1212 to the controller 1220. Alternatively, it is possible that the connection box 1212 includes a transmitter or transceiver 1216 that communicates in a wireless manner with a corresponding transceiver 1226, which is part of the controller 1220. The two transceivers may use any protocol and any frequency spectrum (FM, Wi-Fi, Bluetooth, etc.) for communication and data exchange. One or more of these devices may also be fitted with an appropriate power source to supply electrical energy to the transceivers. The embodiment illustrated in FIG. 12 can be implemented in any type of pipe, i.e., even a type made of a material that suppress electromagnetic waves from passing through the wall.

However, if the pipe 110 is made of a material that allows electromagnetic waves propagation through its walls, e.g., PVC, than it is possible to have the flowmeter 100 made to include a power source, a microcontroller and a transmitter so that no wires are piercing the wall of the pipe. FIG. 13 shows the flowmeter system 1200 including the flowmeter 100 having the microcontroller 1220 and a battery 1320 attached to the base 102. The figure also shows one pressure sensor 106 and one of its terminal 722. Wires 1330 are visible and they are configured to link the pressure sensor 106 to the microcontroller 1220. For this embodiment, the flowmeter 100 was integrated with commercially available electronics 1220 to create a standalone functional system installed inside a pipe. In one application, a Bluetooth Low Energy (BLE) enabled Programmable System on Chip (PSoC) from Cypress™ can be used as the controller 1220. This controller has an internal capacitance to digital convertor (CDC) to connect the three capacitive pressure sensors 106 to the controller without the need for additional Integrated Circuits (ICs), or passive components. The raw CDC values from the pressure sensors 106 can be converted into a capacitance unit using a calibration plot that is obtained prior to deploying the flowmeter. Furthermore, the PSoC has the BLE functionality built-in to enable sending the data wirelessly through the pipe 110. The flowmeter system 1200, which includes the flowmeter 100 and the controller 1220, is powered using a coin cell battery 1320 due to the advantage of the low power consumption of the chip. The battery 1320 can be replaced with an energy generation device that uses the fluid flow to generate energy. The controller was connected to the pressure sensors with the wires 1330 and everything was packaged via a PDMS layer 1340 for insulation.

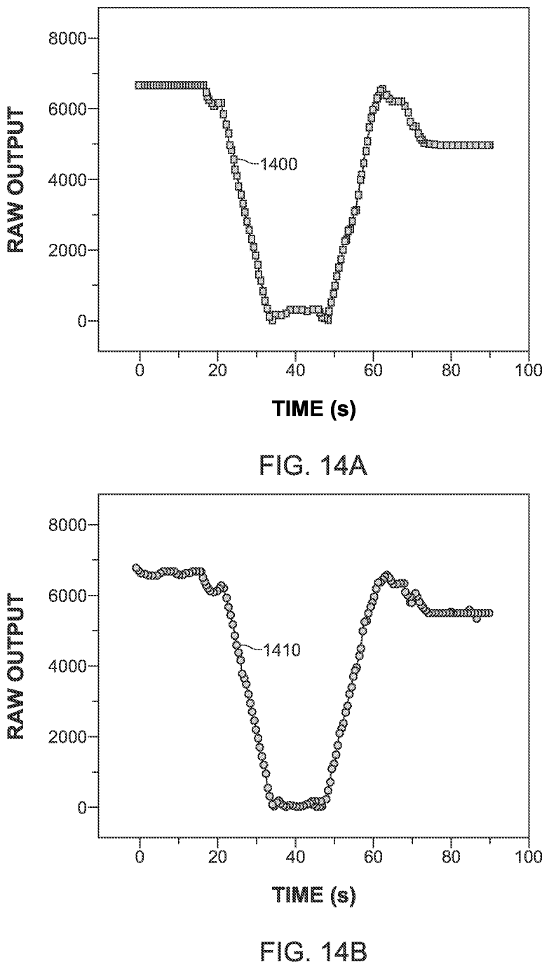

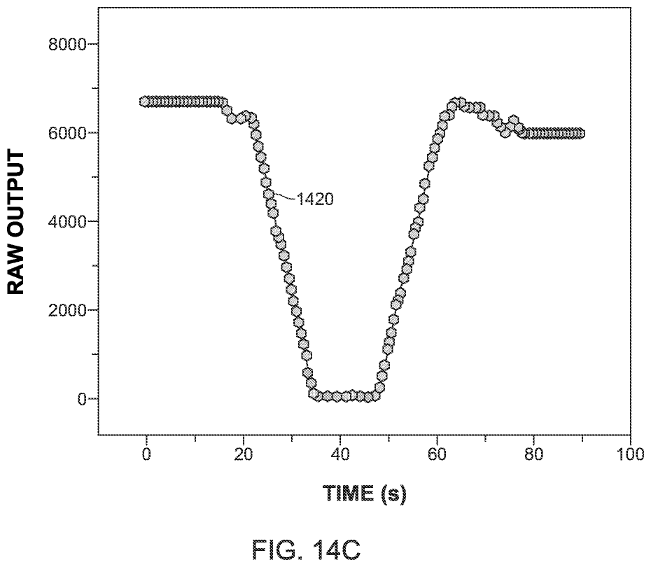

For a plastic pipe with 4 cm in diameter and filled with the fluid 112, the BLE can easily communicate with a mobile device 1350, e.g., laptop, tablet, smartphone, etc., up to 10 m in range. A test was performed with the flowmeter 100 being connected to the controller 1220, and the flowmeter was submerged in water up to 50 cm depths. The data measured by the pressure sensor was sent in real-time from the three sensors to the smartphone 1350. The curves 1400 to 1420 corresponding to the readings from the three pressure sensors 106 are shown in FIGS. 14A to 14C, respectively. It is noted that the three curves are similar to each other. It is also noted that only one pressure sensor is needed for measuring the flow rate through the pipe 110. In this embodiment, three pressure sensors are used to improve the accuracy of the estimated flow rate, and for redundancy.

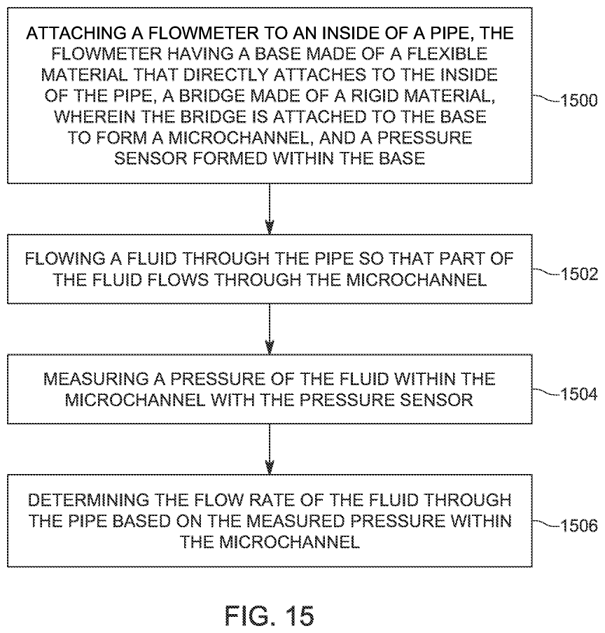

A method for measuring a fluid flow rate through a pipe 110 is now discussed with regard to FIG. 15. The method includes a step 1500 of attaching a flowmeter 100 to an inside of the pipe 110. The flowmeter 100 has a base 102 made of a flexible material that directly attaches to the inside of the pipe 110, a bridge 104 made of a rigid material, where the bridge 104 is attached to the base 102 to form a microchannel 300, and a pressure sensor 106 formed within the base 102. The method further includes a step 1502 of flowing a fluid through the pipe 110 so that part of the fluid flows through the microchannel 300, a step 1504 of measuring a pressure of the fluid within the microchannel 300 with the pressure sensor 106, and a step 1506 of determining the flow rate of the fluid through the pipe 110 based on the measured pressure within the microchannel 300. Some of the steps of the method may be performed within the controller 1220 or in the external device 1350, or they be distributed in both these elements.

The disclosed embodiments provide a flowmeter that is capable of accurately measuring the flow of a liquid through a pipe, by estimating a pressure inside a microchannel formed within the pipe. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] H. Droogendijk et al., “Parametric excitation of a micro Coriolis mass flow sensor,” Appl. Phys. Lett., vol. 101, no. 22, pp. 99-102, 2012, doi: 10.1063/1.4769094.
[2] J. Yao and M. Takei, “Application of process tomography to multiphase flow measurement in industrial and biomedical fields: a review,” IEEE Sensors Journal, vol. 17, no. 24. Institute of Electrical and Electronics Engineers Inc., pp. 8196-8205, 15 Dec. 2017, doi: 10.1109/JSEN.2017.2682929.
[3] R. E. Oosterbroek, T. S. J. Lammerink, J. W. Berenschot, G. J. M. Krijnen, M. C. Elwenspoek, and A. Van Den Berg, “A micromachined pressure r flow-sensor,” Sensors and Actuators, vol. 77, pp. 167-177, 1999.
[4] J. Liu, Y. C. Tai, and C. M. Ho, “MEMS for pressure distribution studies of gaseous flows in microchannels,” Proc. IEEE Micro Electro Mech. Syst., pp. 209-215, 1995, doi: 10.1109/memsys.1995.472578.
[5] W. Song and D. Psaltis, “Optofluidic membrane interferometer: An imaging method for measuring microfluidic pressure and flow rate simultaneously on a chip,” Biomicrofluidics, vol. 5, p. 44110, 2011, doi: 10.1063/1.3664693.
[6] C. Roh, J. Lee, and C. K. Kang, “Physical properties of PDMS (polydimethylsiloxane) microfluidic devices on fluid behaviors: Various diameters and shapes of periodically-embedded microstructures,” Materials (Basel)., vol. 9, no. 10, 2016, doi: 10.3390/ma9100836.
[7] P. Liu, R. Zhu, and R. Que, “A flexible flow sensor system and its characteristics for fluid mechanics measurements,” Sensors, vol. 9, no. 12, pp. 9533-9543, 2009, doi: 10.3390/s91209533.

What is claimed is:

1. A flowmeter for measuring a fluid flow rate in a pipe, the flowmeter comprising:
a base made of a flexible material;
a bridge made of a rigid material, wherein the bridge is attached to the base to form a microchannel; and
a pressure sensor formed within the base,
wherein the microchannel has a height H between 100 and 400 μm.

2. The flowmeter of claim 1, wherein the bridge has two side walls and one top wall, and the height is a distance between the base and the top wall.

3. The flowmeter of claim 1, wherein a length of the microchannel is between 3 and 100 mm.

4. The flowmeter of claim 1, wherein the height H is 250 μm and a length of the microchannel is 60 mm.

5. The flowmeter of claim 1, wherein the pressure sensor has two metal plates formed on opposite surfaces of the base, and a dielectric material placed within the base, between the two metal plates.

6. The flowmeter of claim 5, wherein the dielectric material is air.

7. The flowmeter of claim 5, wherein the base includes first to third layers, the first layer has one of the two metal plates formed over a first surface, the third layer has another one of the two metal plates formed over a second surface, and the second layer, which is sandwiched between the first and the third layers, has a hole corresponding to the first and second plates.

8. The flowmeter of claim 1, wherein the base is made from polydimethylsiloxane (PDMS) and the bridge is formed from poly(methyl-methacrylate) (PMMA).

9. A flowmeter system for measuring a fluid flow rate in a pipe, the flowmeter system comprising:
a flowmeter having a base made of a flexible material, a bridge made of a rigid material, wherein the bridge is attached to the base to form a microchannel, and a pressure sensor formed within the base; and
a microcontroller configured to receive a pressure reading from the pressure sensor and to estimate the fluid flow rate through a pipe in which the flowmeter is located.

10. The flowmeter system of claim 9, wherein the microchannel has a height H between 100 and 400 μm.

11. The flowmeter system of claim 9, wherein the microcontroller is formed on the base, and the microcontroller includes a processor, a power source, and a transmitter configured to transmit pressure readings, in a wireless manner, from the flowmeter to a device external to the pipe.

12. The flowmeter system of claim 9, wherein the microcontroller is formed outside the pipe, and the microcontroller includes a processor, a power source, and a wire that is connected to the flowmeter to receive pressure readings.

13. The flowmeter system of claim 9, wherein the base is attached to an internal wall of the pipe so that a longitudinal axis of the microchannel is parallel to a longitudinal axis of the pipe.

14. The flowmeter system of claim 9, wherein the bridge has two side walls and one top wall, the height is a distance between the base and the top wall, and the height is substantially 250 μm.

15. The flowmeter system of claim 9, wherein the height H is 250 μm and a length of the microchannel is 60 mm.

16. The flowmeter system of claim 9, wherein the pressure sensor has two metal plates formed on opposite surfaces of the base, and a dielectric material placed within the base, between the two metal plates.

17. The flowmeter system of claim 16, wherein the dielectric material is air.

18. The flowmeter system of claim 16, wherein the base includes first to third layers, the first layer has one of the two metal plates formed over a first surface, the third layer has another one of the two metal plates formed over a second surface, and the second layer, which is sandwiched between the first and the third layers, has a hole corresponding to the first and second plates.

19. The flowmeter of claim 16, wherein the base is made from polydimethylsiloxane (PDMS) and the bridge is formed from poly(methyl-methacrylate) (PMMA).

20. A method for measuring a fluid flow rate through a pipe, the method comprising:
attaching a flowmeter to an inside of a pipe, the flowmeter having a base made of a flexible material that directly attaches to the inside of the pipe, a bridge made of a rigid material, wherein the bridge is attached to the base to form a microchannel, and a pressure sensor formed within the base;
flowing a fluid through the pipe so that part of the fluid flows through the microchannel;
measuring a pressure of the fluid within the microchannel with the pressure sensor; and
determining the flow rate of the fluid through the pipe based on the measured pressure within the microchannel.
